(19) United States
(12) Patent Application Publication
(10) Pub. No.: US 2006/0126774 A1
(43) Pub. Date: Jun. 15, 2006

(54) Internal circulating irradiation capsule for iodine-125 and method of producing iodine-125 using same

(75) Inventors: Heon Il Kim, Daejeon-si (KR); Ul Jae Park, Daejeon-si (KR); Byung Jin Jun, Kongju-si (KR); Hyon Soo Han, Daejeon-si (KR)

Correspondence Address: BACHMAN & LAPOINTE, P.C., 900 CHAPEL STREET, SUITE 1201, NEW HAVEN, CT, 06510, US

(73) Assignee: Korea Atomic Energy Research Institute

(21) Appl. No.: 11/133,131

(22) Filed: May 18, 2005

(30) Foreign Application Priority Data
Dec. 12, 2004 (KR) KR2004-0109720

(51) Int. Cl. G21G 1/00

(52) U.S. Cl. 376/202

(57) ABSTRACT

A present invention provides an internal circulating irradiation capsule available for the production of iodine-125 and a related production method. The irradiation capsule filled with xenon gas has a lower irradiation part, an upper irradiation part, and a neutron control member. The lower irradiation part is inserted into an irradiation hole of a reactor core and irradiated with a large quantity of neutron directly. When neutron is radiated to the xenon gas, iodine-125 is produced from xenon gas. The upper irradiation part protrudes from the irradiation hole, and iodine-125 is transferred to the upper irradiation part by convection and solidified in the upper part. The neutron control member reduces neutron in the upper part to produce iodine-125 of high purity and radioactivity in a large quantity.

### BACKGROUND OF THE INVENTION

1. Field of the Invention

The present invention relates generally to an apparatus and a method for producing iodine-125 (¹²⁵I) and, more particularly, to an internal circulating irradiation capsule available for producing iodine-125 for medical radioisotope and a related producing method.

2. Description of the Related Art

In the early years iodine radioactive nuclide was produced by an accelerator or cyclotron in a small quantity for research purposes only. Radioactive iodine was further used for the study of a physiological function of thyroid gland in 1938 and has been used for tumor therapy. Thereafter, radioactive iodine has been utilized for widespread applications in radioactive medicine.

Since halogen elements may be easily substituted in almost all organic compounds and may have higher yield and stability in products, they may be widely employed for the synthesis of labeled substances. Iodine is a typical one of them. Iodine radioactive nuclide includes iodine-123 (¹²³I), iodine-124 (¹²⁴I), iodine-125 (¹²⁵I), iodine-128 (¹²⁸I), iodine-131 (¹³¹I) and iodine-132 (¹³²I). An accelerator may produce iodine-123 and iodine-124, whereas an atomic reactor may produce iodine-125, iodine-128, iodine-131 and iodine-132. Among them, iodine-123, iodine 125 and iodine 131 may be widely used in nuclear medicine. In particular, iodine-125 may be used as a tracer due to low gamma energy (35 keV) and long half-life (60.2 days), and further used for in-vitro diagnosis reagent or a radiation source in seeds or wires used in brachytherapy.

A series of nuclear reactions related to the production of iodine-125 is shown in FIG. 1. Referring to FIG. 1, xenon-124 (¹²⁴Xe) constituting about 0.096 percent of xenon gas is changed to xenon-125 (¹²⁵Xe) by absorbing neutrons and then xenon-125 decays in electron capture (EC) manner to form iodine-125. As time passes, iodine-125 is changed to stable isotope tellurium-125 (¹²⁵Te). However, since iodine-125 has a large cross section for absorbing neutron, it may absorb neutron in the neutron flux field to create iodine-126. The target material may include enriched xenon gas from xenon-124, natural xenon gas, or solid xenon compound such as XeF₂. In order to produce iodine-125 of high purity and radioactivity, the separation and purification of iodine-125 produced from xenon target are important. However, above all, it is essential to select proper irradiation conditions, and moreover, to minimize the concentration of iodine-126 created from iodine-125 by absorbing neutron again.

A conventional method of producing iodine-125 has three types of neutron irradiation, namely, batch process, circulating loop process, and batch-operated loop process. The batch process is suitable for research purposes, the production of small quantities of iodine-125, or the irradiation of a large quantity of natural xenon gas. This process uses an irradiation capsule 101 shown in FIG. 2. In a typical batch process, xenon gas 103 is filled in the irradiation capsule 101, made of zircaloy or aluminum, at the temperature of liquid nitrogen. The capsule 101 is sealed with a cap 105 and then subjected to the radiation of neutron α.

As discussed above, iodine-125 produced in the batch process absorbs neutron and is transformed into iodine-126 acting as radionuclidic contaminant. Iodine-126 emits gamma rays different from low energy gamma rays of iodine-125, so gamma rays of iodine-126 may cause problems during radiotherapy and diagnosis. Therefore, the percentage of iodine-126 should be controlled less than one percent, and a longer cooling time may be required. Specific radioactivity of iodine-125, i.e., radioactivity per unit weight or chemical equivalent, is decreased and this process is not suitable for mass production due to low economical efficiency. Additionally, a recovery equipment for xenon gas is needed after radiation of neutron.

In the circulating loop process, iodine-125 is produced by continuously irradiating xenon-124 in the neutron flux field to get xenon-125, which then decays to form iodine-125 in a vessel placed in the outside of an irradiation hole of an atomic reactor. Iodine-125 is absorbed on charcoal, stainless steel or aluminum wool. Since this process allows a continuous circulation of xenon gas, the residence time of xenon-125 in the neutron flux field is shorter. It has therefore advantages of not only preventing the creation of undesirable iodine-126, but also obtaining pure iodine-125. However, this process has disadvantages that costs of equipment and processing are higher than those of any other processes.

The batch-operated loop process is a combination of the batch process and the circulating loop process. As shown in FIG. 3, the batch-operated loop process uses an irradiation capsule assembly 200 that includes an irradiation capsule 201 and a decay capsule 203. In this process, xenon gas condensed in a cooling trap is vaporized at a room temperature and transferred to the irradiation capsule 201. Then neutron is radiated to xenon gas in an atomic reactor 205 for a designated time, for example, 16 to 18 hours. After neutron radiation, xenon gas is transferred to the decay capsule 203 and decays to form iodine-125. Subsequently, xenon gas is circulated to the irradiation capsule 201 again and again several times. Although this process has an advantage in obtaining iodine-125 of high purity and radioactivity, it may have disadvantages that costs of equipment and processing are also high like the aforementioned circulating loop process.

### SUMMARY OF THE INVENTION

Exemplary, non-limiting embodiments of the present invention provide an internal circulating neutron irradiation capsule available for the production of iodine-125 and a related production method.

According to an exemplary embodiment of the present invention, an irradiation capsule filled with xenon gas comprises a lower irradiation part, an upper irradiation part, and a neutron control member. The lower irradiation part is inserted into an irradiation hole of a reactor core. In the lower irradiation part, xenon gas is irradiated with a large quantity of neutron directly to produce iodine-125. The upper irradiation part protrudes from the irradiation hole, and the neutron control member is formed in the upper irradiation part so as to reduce neutron.

In an alternative exemplary embodiment of the invention, the neutron control member may be a venturi tube formed between the lower irradiation part and the upper irradiation part. The venturi tube may have an inner baffle tube placed therein and the inner baffle tube has a reduced shape of the ventri tube.

In another alternative exemplary embodiments of the invention, the neutron control member may be a porous screen formed between the lower irradiation part and the upper irradiation part, or a neutron absorbent coat coated on an inner wall of the upper irradiation part.

In still another alternative exemplary embodiments of the invention, the lower irradiation part may have a heat-preserving member, and the upper irradiation part may have a cooling member.

According to further exemplary embodiment of the invention, the method of producing iodine-125 comprises a step of inserting an irradiation capsule filled with xenon gas into an irradiation hole of a reactor core such that an upper part of the irradiation capsule protrudes from the irradiation hole; a step of radiating neutron to the xenon gas such that xenon-124 is transformed into xenon-125 by absorbing neutron and then the xenon-125 decays to create iodine-125; and after the iodine-125 is transferred from the lower part to the upper part by convection and then solidified on an inner wall of the upper part; and a step of obtaining the solidified iodine-125 from the inner wall of the upper part.

### BRIEF DESCRIPTION OF THE DRAWINGS

FIG. 1 is a diagram showing a series of nuclear reactions related to the production of iodine-125.

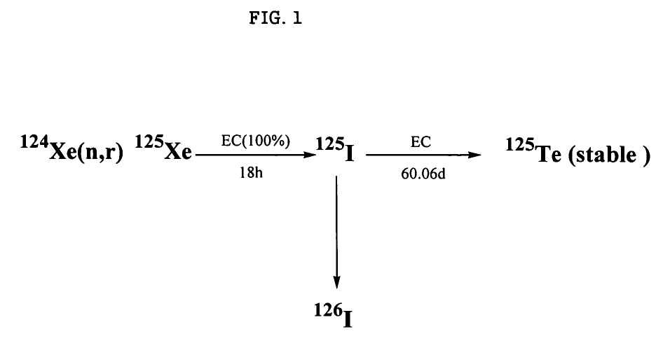

FIG. 2 is a cross-sectional view showing a conventional neutron irradiation capsule used for a batch process.

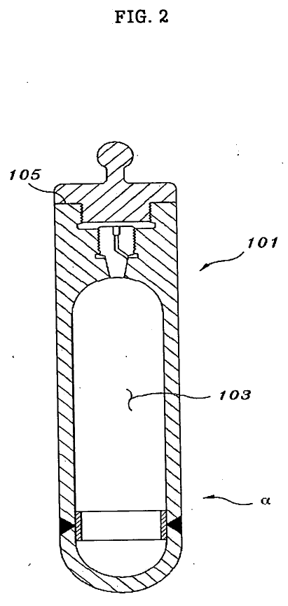

FIG. 3 is a schematic view showing a conventional neutron irradiation capsule used for a batch-operated loop process.

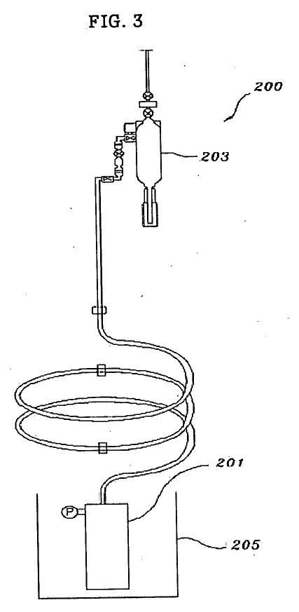

FIG. 4 is a cross-sectional view showing a neutron irradiation capsule in accordance with an exemplary embodiment of the present invention.

FIG. 5 is a cross-sectional view showing parts of a neutron irradiation capsule in accordance with another exemplary embodiment of the present invention.

FIG. 6 is a cross-sectional view showing parts of a neutron irradiation capsule in accordance with yet another exemplary embodiment of the present invention.

FIG. 7 is a cross-sectional view showing a neutron irradiation capsule in accordance with still another exemplary embodiment of the present invention.

FIG. 8 is a partial perspective view taken along the line A-A in FIG. 7.

### DETAILED DESCRIPTION OF EXEMPLARY EMBODIMENTS OF THE INVENTION

Exemplary, non-limiting embodiments of the present invention will now be described more fully hereinafter with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and feature of this invention may be employed in varied and numerous embodiments without departing from the scope of the invention.

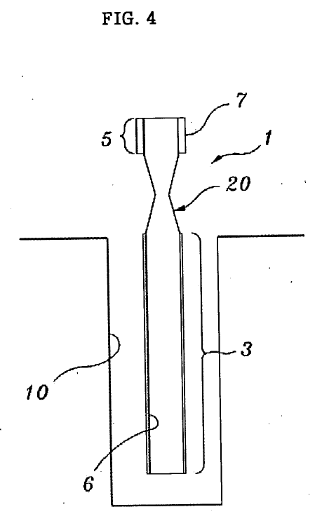

FIG. 4 shows, in a cross-sectional view, an internal circulating irradiation capsule 1 available for the production of iodine-125 in accordance with an exemplary embodiment of the present invention. As shown in FIG. 4, the irradiation capsule 1 has a longish hollow cylindrical shape. The irradiation capsule 1 is inserted into an irradiation hole 10 of a reactor core and is subjected to the radiation of neutron. The irradiation capsule 1 is loaded with xenon gas and iodine-125 is produced by irradiating xenon gas with neutron.

The irradiation capsule 1 protrudes partially from the irradiation hole 10. That is, the irradiation capsule 1 comprises a lower part 3 located inside the irradiation hole 10 and an upper part 5 located outside the irradiation hole 10. While the lower part 3 is a direct irradiation part to which neutron is radiated directly, the upper part 5 is an indirect irradiation part to which neutron is radiated indirectly.

Xenon gas filled in the lower, direct irradiation part 3 is subjected to the neutron flux field and then heated by absorbing neutron and gamma rays. High-temperature xenon gas and iodine-125 gas produced from xenon gas are transferred upward by convection. The upper, indirect irradiation part 5 is in a state of relatively lower temperature due to little possibility of absorbing neutron and gamma rays. So, xenon gas and iodine-125 gas transferred from the lower irradiation part 3 are touched on a relatively cold, inner wall of the upper irradiation part 5 and thereby solidified.

The upper irradiation part 5 has a neutron control member 20 configured to restrict an inflow of neutron from the lower irradiation part 3. It is therefore possible to prevent iodine-125 in the upper irradiation part 5 from being transformed into undesirable iodine-126 by absorbing neutron.

In this embodiment, the neutron control member 20 is a venturi tube, which has a constricted throat formed at a place where two irradiation parts 3 and 5 are connected to each other. The constricted throat of the venturi tube 20 restricts the upward flow of neutron coming from the lower irradiation part 3 and thereby reduces the neutron flux in the upper irradiation part 5.

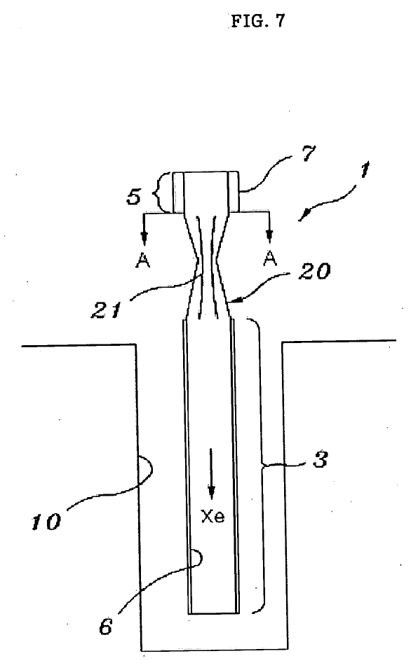

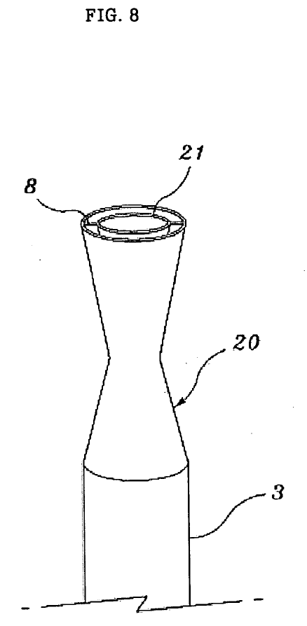

In another embodiment of the present invention, the venturi tube 20 may further have an inner baffle tube 21 as shown in FIGS. 7 and 8. If the constricted throat of the venturi tube 20 is very small in diameter, it may cause trouble in flow of iodine-125 gas into the upper irradiation part 5. In such a case, the inner baffle tube 21 is provided to promote smooth circulations of internal gases in the irradiation capsule 1. The inner baffle tube 21 having reduced shape of ventri tube 20 is placed inside the venturi tube 20 along the axis of the irradiation capsule and connected to the venturi tube 20 through a supporter 8.

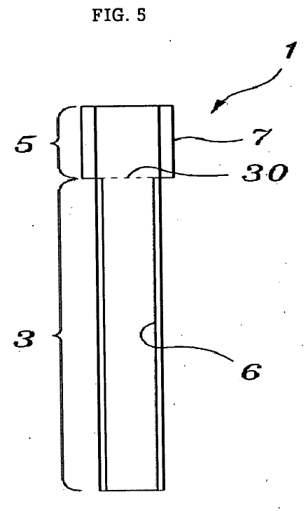

Another neutron control members may be alternatively used instead of the above-discussed venturi tube 20. FIG. 5 shows a porous screen 30 as one alternative example of the neutron control member. The porous screen 30 is placed at the interface between two irradiation parts 3 and 5. The porous screen 30 has a number of minute openings, such as holes, which restrict the upward flow of neutron and allow the circulations of internal gases.

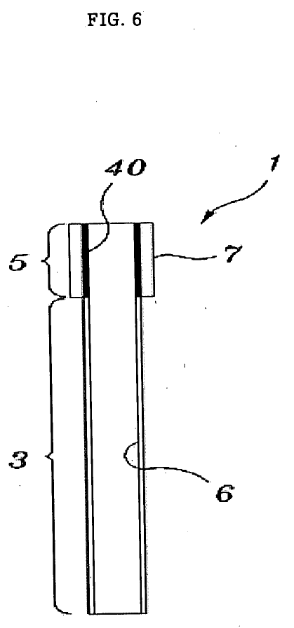

FIG. 6 shows a neutron absorbent coat 40 as another alternative example of the neutron control member. The neutron absorbent coat 40 capable of absorbing neutron is coated on the inner wall of the upper irradiation part 5. Unless the neutron flux rapidly reduces, for example, when the irradiation hole 10 is filled with heavy water, the neutron absorbent coat 40 may be desirably used instead of a relatively longer irradiation capsule 1. In addition, the neutron absorbent coat 40 may be used together with the above-discussed venturi tube 20 or porous screen 30.

It is desirable that the lower and upper irradiation parts 3 and 5 keep higher and lower temperatures, respectively, allowing active convection in the lower irradiation part and solidifying phenomenon in the upper irradiation part. For such purposes, the lower irradiation part 3 may have a heat-preserving member 6, whereas the upper irradiation part 5 may further have a cooling member 7. The heat-preserving member 6 preserves heat generated when xenon gas is transformed into iodine-125. Therefore, the lower irradiation part 3 can keep a temperature higher than the vaporization point of iodine. A dual vacuum tube having inner tube 6 may be used as the heat-preserving member. The cooling member removes heat from the upper irradiation part 5 such that the upper irradiation part 5 can be kept at a temperature lower than the solidifying point of iodine. A number of cooling fins 7 may be used as the cooling member.

The following is a method of producing iodine-125 by using the irradiation capsule 1 of the present invention.

The irradiation capsule 1 is filled with xenon gas and sealed. Then the irradiation capsule 1 is inserted into the irradiation hole 10 of a reactor core. Since the length of the irradiation capsule 1 is longer than the depth of the irradiation hole 10, the upper irradiation part 5 of the irradiation capsule 1 protrudes from the irradiation hole 10.

Subsequently, when the irradiation capsule 1 is subjected to the radiation of neutron in the irradiation hole 10, xenon-124 filled in the lower irradiation part 3 absorbs neutron and is turned into xenon-125. Then iodine-125 is produced from xenon-125 through beta decay. Such reactions generate heat, which is applied to internal gases. High-temperature xenon gas and iodine-125 gas are transferred to the upper irradiation part 5 by convection. The velocity of convection is sufficiently high. So, there is little possibility that iodine-125 is transformed into undesirable iodine-126 by absorbing neutron before touched on the upper irradiation part 5.

Iodine-125 gas flowing into the upper irradiation part 5 is touched on the inner wall, cooled, and solidified. After solidified on the wall, iodine-125 may be very seldom transformed into undesirable iodine-126 due to the low neutron flux in the upper irradiation part 5.

Then solidified iodine-125 is obtained from the inner wall of the upper irradiation part 5. Such process allows a remarkable increase in neutron radiation time, so mass production of iodine-125 is possible.

As discussed above, the irradiation capsule of the present invention keeps the lower part to a temperature higher than the vaporization point of iodine-125 and keeps the upper part to a temperature lower than the solidifying point of iodine-125. Iodine-125 gas is heated in the lower part, transferred upward to the upper part, and solidified in the upper part. Then solidified iodine-125 is obtained sorting from radionuclidic contaminant such as iodine-126. It is therefore possible to produce iodine-125 of high purity and radioactivity in a large quantity.

The irradiation capsule and the production method of the present invention not only can produce iodine-125 of higher purity and radioactivity when compared with conventional batch process, but also can have a simple structure and cost-effective process when compared with conventional circulating loop process.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. An internal circulating irradiation capsule for producing iodine-125, the irradiation capsule being filled with xenon gas and irradiated with neutron, the irradiation capsule comprising:
a lower irradiation part inserted into an irradiation hole of a reactor core, wherein a large quantity of neutron is radiated to the xenon gas;
an upper irradiation part protruding from the irradiation hole; and
a neutron control member formed in the upper irradiation part so as to reduce neutron.

2. The irradiation capsule of claim 1, wherein the neutron control member is a venturi tube formed between the lower irradiation part and the upper irradiation part.

3. The irradiation capsule of claim 2, wherein an inner baffle tube is placed in the venturi tube along the axis of the irradiation capsule.

4. The irradiation capsule of claim 1, wherein the neutron control member is a porous screen formed between the lower irradiation part and the upper irradiation part.

5. The irradiation capsule of claim 1, wherein the neutron control member is a neutron absorbent coat coated on an inner wall of the upper irradiation part.

6. The irradiation capsule of any of claims 1, wherein the lower irradiation part has a heat-preserving member.

7. The irradiation capsule of claim 6, wherein the heat-preserving member is a dual tube having an inner tube

8. The irradiation capsule of any of claims 1, wherein the upper irradiation part has a cooling member.

9. The irradiation capsule of claim 8, wherein the cooling member is a cooling fin.

10. A method of producing iodine-125, the method comprising the steps of:
(a) inserting an irradiation capsule filled with xenon gas into an irradiation hole of a reactor core such that an upper part of the irradiation capsule protrudes from the irradiation hole;
(b) radiating neutron to the xenon gas such that xenon-124 is transformed into xenon-125 by absorbing neutron,wherein heat is generated, and then the xenon-125 decays to iodine-125;
(c) transferring the iodine-125 by convection from the lower part to the upper part and then solidifying the iodine-125 by cooling on an inner wall of the upper part; and
(d) collecting the solidified iodine-125 from the inner wall of the upper part.
